(19) United States
(12) Patent Application Publication
(10) Pub. No.: US 2025/0383484 A1
(43) Pub. Date: Dec. 18, 2025

(54) OPTICAL NAVIGATION DEVICE

(71) Applicant: PixArt Imaging Inc., Hsin-Chu City (TW)

(72) Inventors: Yee Loong CHIN, Penang (MY); Wan Piang Lim, Penang (MY); Sai Mun Lee, Penang (MY)

(73) Assignee: PixArt Imaging Inc., Hsin-Chu City (TW)

(21) Appl. No.: 18/744,697

(22) Filed: Jun. 16, 2024

(51) Int. Cl. G02B 5/04; G02B 3/00; G02B 5/00; G02B 5/02

(52) U.S. Cl. CPC G02B 5/04; G02B 3/0043; G02B 3/0075; G02B 5/003; G02B 5/0294

(57) ABSTRACT

An optical navigation device includes a case, an illumination light source, an illumination lens, an optical detector and a first optical element. The case is movably located above a navigation surface. The illumination light source is disposed inside the case and adapted to emit an illumination beam. The illumination lens is disposed under the illumination light source and has an output surface. The illumination beam passes through the output surface to project onto the navigation surface. The optical detector is disposed inside the case and adapted to detect a reflection beam from the navigation surface. The first optical element is disposed adjacent to the output surface of the illumination lens and extended to an outer edge of the illumination lens, and adapted to eliminate a stray light beam generated by the illumination beam propagated between the illumination lens and the navigation surface from reaching the navigation surface.

### BACKGROUND OF THE INVENTION

### 1. Field of the Invention

The present invention relates to an optical navigation device, and more particularly, to an optical navigation device of increasing detection accuracy of the optical detector without detection of the stray light beam and the scattered beam.

### 2. Description of the Prior Art

A conventional optical navigation device includes an illumination channel and an imaging channel. The illumination channel has a light source, an aperture and an illumination lens. An illumination beam emitted by the light source passes through the aperture and the illumination lens to project onto a navigation surface. The imaging channel has an imaging lens, another aperture and an optical detector. A reflection beam generated by the illumination beam projected onto the navigation surface passes through the imaging lens and the aperture and is received by the optical detector. When the optical navigation device is lifted relative to the navigation surface at a certain height, some part of the illumination beam emitted by the light source is leaked through a flat surface of the illumination lens adjacent to an output surface of the illumination channel to create a stray light beam, and the optical detector receives the stray light beam to generate an undesired secondary signal. Detection accuracy of the optical detector is affected by the undesired secondary signal, which decreases navigation accuracy of the optical navigation device at the certain height. Thus, design of an optical navigation device of effectively preventing interference of the undesired secondary signal is an important issue in the related optical apparatus industry.

### SUMMARY OF THE INVENTION

The present invention provides an optical navigation device of increasing detection accuracy of the optical detector without detection of the stray light beam and the scattered beam for solving above drawbacks.

According to the claimed invention, an optical navigation device includes a case, an illumination light source, an illumination lens, an optical detector and a first optical element. The case is movably located above a navigation surface. The illumination light source is disposed inside the case and adapted to emit an illumination beam. The illumination lens is disposed under the illumination light source and has an output surface. The illumination beam passes through the output surface to project onto the navigation surface. The optical detector is disposed inside the case and adapted to detect a reflection beam from the navigation surface. The first optical element is disposed adjacent to the output surface of the illumination lens and extended to an outer edge of the illumination lens, and adapted to eliminate a stray light beam generated by the illumination beam propagated between the illumination lens and the navigation surface and further to prevent the stray light from reaching the navigation surface.

According to the claimed invention, the first optical element is a front prism block adapted to deflect the stray light beam away from a field of view of the optical detector. The front prism block includes a first surface and a second surface disposed on different positions, the first surface is disposed adjacent to the output surface, and the second surface is disposed adjacent to the outer edge. The first surface has a function of total internal reflection, an included angle formed between a planar normal vector of the first surface and a planar normal vector of the navigation surface is substantially equal to forty-five degrees, and the first surface is adapted to totally reflect the stray light beam sideway to the second surface. The second surface is adapted to refract the stray light beam in a preset direction away from the navigation surface. The first surface is adapted to refract the stray light beam in another preset direction away from a field of view of the optical detector.

According to the claimed invention, the first optical element is an opaque layer adapted to absorb the stray light beam to prevent the stray light beam from being projected onto the navigation surface. The first optical element is an optical deflection layer adapted to reflect or refract the stray light beam away from the navigation surface. The first optical element is an optical diffusion layer adapted to diffuse the stray light beam away from the navigation surface. The first optical element is disposed around the output surface to provide mechanical protection.

According to the claimed invention, the optical navigation device further includes a second optical element disposed on a lateral surface of the illumination lens, and adapted to eliminate an undesired secondary signal generated by the illumination beam propagated between the illumination lens and the navigation surface. The second optical element is a side prism block adapted to reflect and/or refract a scattered beam generated by the illumination beam projected onto the navigation surface, so as to cut down retro-reflection of the scattered beam and eliminate the undesired secondary signal.

According to the claimed invention, the second optical element is an opaque layer adapted to absorb a scattered beam generated by the illumination beam projected onto the navigation surface; or, the second optical element is an optical deflection layer adapted to reflect or refract a scattered beam generated by the illumination beam projected onto the navigation surface; or, the second optical element is an optical diffusion layer adapted to diffuse a scattered beam generated by the illumination beam projected onto the navigation surface.

According to the claimed invention, the optical navigation device further includes an imaging lens disposed on a position of the illumination lens opposite to the first optical element to align with the optical detector. The optical navigation device further includes a lens component formed by the illumination lens, the imaging lens, the first optical element and the second optical element monolithically integrated with each other.

The optical navigation device of the present invention can dispose the first optical element and the second optical element around the output surface of the illumination lens. The first optical element can change the transmission direction of the stray light beam inside the lens component, and eliminate the stray light beam generated by the illumination beam propagated between the illumination lens and the navigation surface, so as to prevent the stray light beam from being projected onto the navigation surface and received by the optical detector. The first optical element can use functions of light reflection, light absorption, light refraction and light diffusion to avoid the stray light beam from being projected onto the navigation surface, and can apply the mechanical protection for the illumination lens.

The second optical element can change the transmission direction of the scattered beam inside the lens component, and eliminate the undesired secondary signal generated by the illumination beam propagated between the illumination lens and the navigation surface, so as to avoid the scattered beam from being projected onto the navigation surface and received by the optical detector due to retro-reflection. The second optical element can use functions of the light reflection, the light absorption, the light refraction and the light diffusion to avoid the scattered beam from returning to the navigation surface. Comparing to the prior art, the optical navigation device of the present invention can dispose the first optical element and the second optical element adjacent to the illumination lens, which can effectively prevent the optical detector from detecting the stray light beam and the scattered beam, thereby significantly improving the detection accuracy of the optical detector.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a structural side view of an optical navigation device according to an embodiment of the present invention.

FIG. 2 is a diagram of a lens component according to the embodiment of the present invention.

FIG. 3 is a diagram of transmission paths of an illumination beam and a stray light beam according to the embodiment of the present invention.

FIG. 4 is a structural side view of the optical navigation device according to other embodiment of the present invention.

FIG. 5 is a structural side view of the optical navigation device according to another embodiment of the present invention.

### DETAILED DESCRIPTION

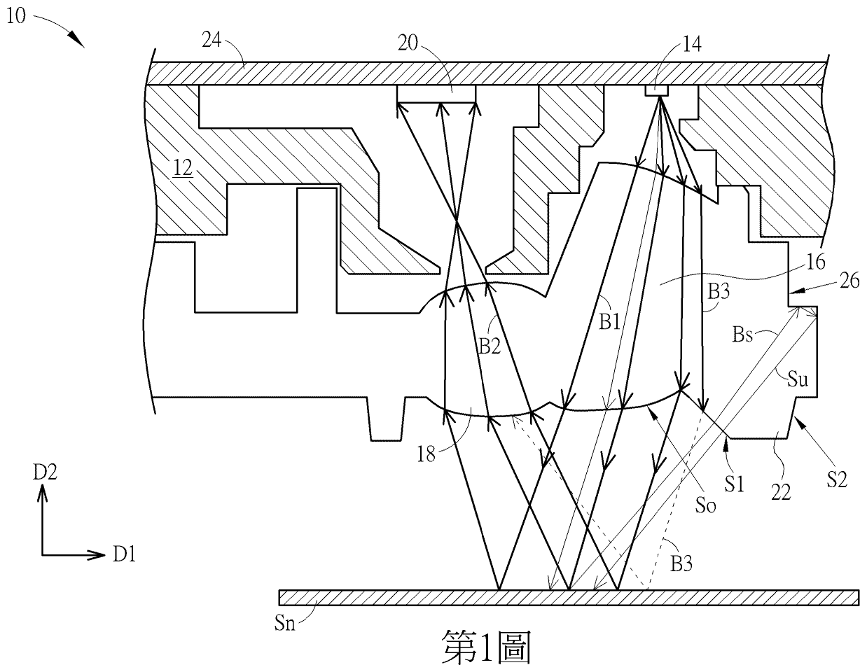

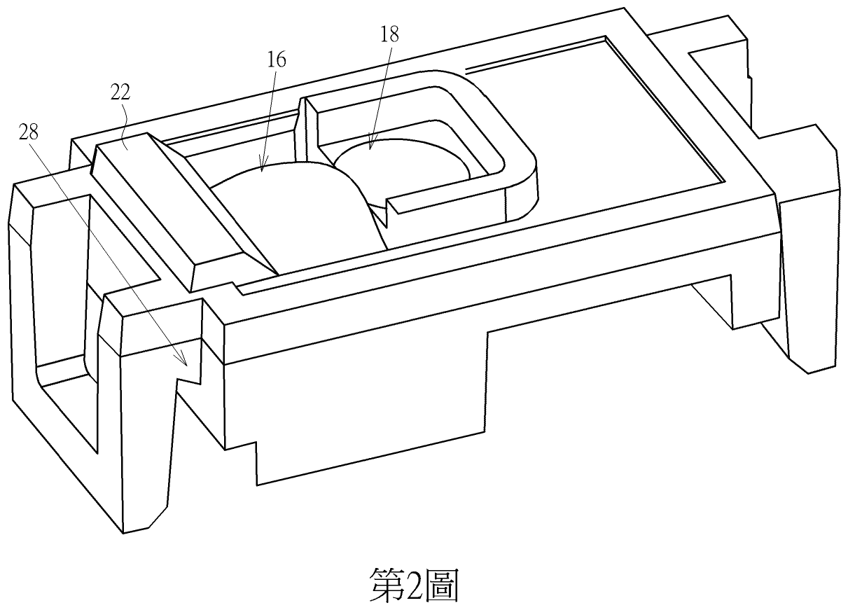

Please refer to FIG. 1 and FIG. 2. FIG. 1 is a structural side view of an optical navigation device 10 according to an embodiment of the present invention. FIG. 2 is a diagram of a lens component according to the embodiment of the present invention. The optical navigation device 10 can be, but not limited to, an optical mouse. The optical navigation device 10 can at least include a case 12, an illumination light source 14, an illumination lens 16, an imaging lens 18, an optical detector 20 and a first optical element 22. The case 12 can have a circuit board 24; the illumination light source 14 and the optical detector 20 can be electrically connected to the circuit board 24 and disposed inside the case 12. The case 12 can be moved relative to the navigation surface Sn laterally in a first direction D1 and/or vertically in a second direction D2.

The illumination lens 16 can be disposed adjacent to the illumination light source 14, and has an output surface So. The illumination light source 14 can emit an illumination beam B1, and the illumination beam B1 can pass through the output surface So of the illumination lens 16 and be projected onto the navigation surface Sn. The imaging lens 18 can be disposed on position of the illumination lens 16 opposite to the first optical element 22, and align with the optical detector 20. The optical detector 20 can be disposed adjacent to the illumination light source 14, and used to receive a reflection beam B2 from the navigation surface Sn. If the navigation surface Sn has a feature point, the optical detector 20 can analyze variation of the feature point contained by the reflection beam B2 to decide relative motion between the optical navigation device 10 and the navigation surface Sn. The first optical element 22 can be disposed adjacent to the output surface So of the illumination lens 16, and extended to an outer edge 26 of the illumination lens 16.

In the embodiment, the illumination lens 16, the imaging lens 18 and the first optical element 22 can be monolithically integrated with each other to set as the lens component, as shown in FIG. 2, and practical application of the lens component is not limited to the foresaid embodiment. For example, the illumination lens 16, the imaging lens 18 and the first optical element 22 may respectively be optical elements independent from each other, or the lens component may further include other optical element. In the present invention, most of the illumination beam B1 can pass through the output surface So of the illumination lens 16 to project onto the navigation surface Sn, but there is still a small amount of output beams from the illumination light source 14 can be indicated as a stray light beam B3 used to project onto an area of the illumination lens 16 other than the output surface So. Therefore, the present invention can dispose the first optical element 22 on the foresaid area of the illumination lens 16 other than the output surface So, and can prevent the stray light beam B3 from being projected onto the navigation surface Sn and further reflected towards the optical detector 20; that is to say, the first optical element 22 can avoid the stray light beam B3 from passing through the imaging lens 18 and entering the optical detector 20 along the dashed path.

The first optical element 22 can eliminate the stray light beam B3 generated by the illumination beam B1 propagated between the illumination lens 16 and the navigation surface Sn, or can be interpreted as deflecting the stray light beam B3 transmitted inside the lens component. The stray light beam B3 is not projected onto the navigation surface Sn and can be transmitted away from a field of view of the optical detector 20 via the first optical element 22, so as to prevent the stray light beam B3 from being projected onto the navigation surface Sn and then reflected towards the optical detector 20. In the embodiment, the first optical element 22 can be defined as a front prism block; the front prism block can have a first surface S1 and a second surface S2 opposite to each other. The first surface S1 can be disposed on position adjacent to the output surface So. The second surface S2 can be disposed on position adjacent to the outer edge 26. The first surface S1 can deflect the stray light beam B3 to be away from the field of view of the optical detector 20. The second surface S2 can guide the stray light beam B3 out of the lens component.

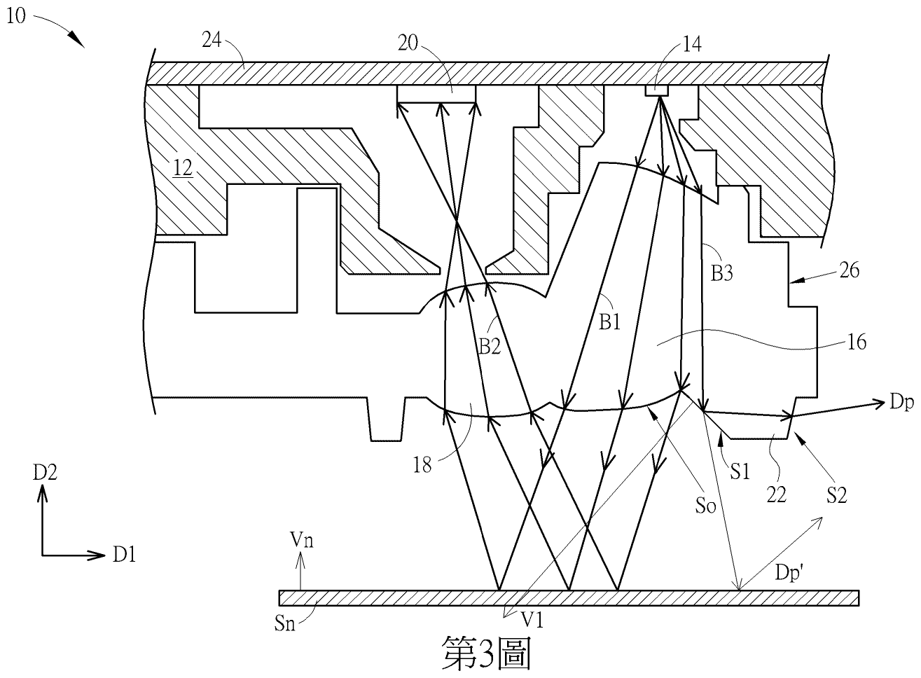

Please refer to FIG. 1 and FIG. 3. FIG. 3 is a diagram of transmission paths of the illumination beam B1 and the stray light beam B3 according to the embodiment of the present invention. The stray light beam B3 can be defined as a part of the illumination beam B1 that passes through the area of the illumination lens 16 other than the output surface So. The present invention can avoid the stray light beam B3 from being projected onto the navigation surface Sn along the dashed path shown in FIG. 1 via design of the first optical element 22; accordingly, the present invention can utilize the first optical element 22 to project the stray light beam B3 onto outside of the lens component along a transmission path (such as a solid line and a related arrow) shown in FIG. 3, so as to prevent the stray light beam B3 from being detected by the optical detector 20 due to reflection of the navigation surface Sn, for effectively increasing navigation accuracy of the optical navigation device 10.

In the embodiment, the first surface S1 of the first optical element 22 can have a feature of total internal reflection, and an included angle formed between a planar normal vector V1 of the first surface S1 and a planar normal vector Vn of the navigation surface Sn can be preferably equal to forty-five degrees. Therefore, the first surface S1 can be used to totally reflect the stray light beam B3 sideway to the second surface S2; then, the stray light beam B3 can be refracted by the second surface S2 in a preset direction Dp to move away from the navigation surface Sn. It should be mentioned that the included angle between the planar normal vector V1 of the first surface S1 and the planar normal vector Vn of the navigation surface Sn is not limited to the forty-five degrees as mentioned above, and may have a tolerance of ten to twenty percent. Any element that can deflect the stray light beam B3 towards the second surface S2 in the preset direction Dp can belong to a design scope of the first optical element 22 in the present invention.

Besides, a small amount of the stray light beam B3 may pass through the first surface S1, and the embodiment can utilize refraction of the first surface S1 to transmit the stray light beam B3 towards another preset direction Dp′ for being away from the navigation surface Sn. As shown in FIG. 3, the stray light beam B3 which passes through the first optical element 22 can be projected onto the navigation surface Sn in the another preset direction Dp′ due to media difference in the first optical element 22 and an air gap (which means space between the lens component and the navigation surface Sn), and can be further reflected or refracted towards the outside of the lens component away from the field of view of the optical detector 20. The first surface S1 may optionally have a refraction function; the first surface S1 does not have the refraction function if the first optical element 22 has the preferred function of total internal reflection. Practical application of the first surface S1 can depend on a design demand.

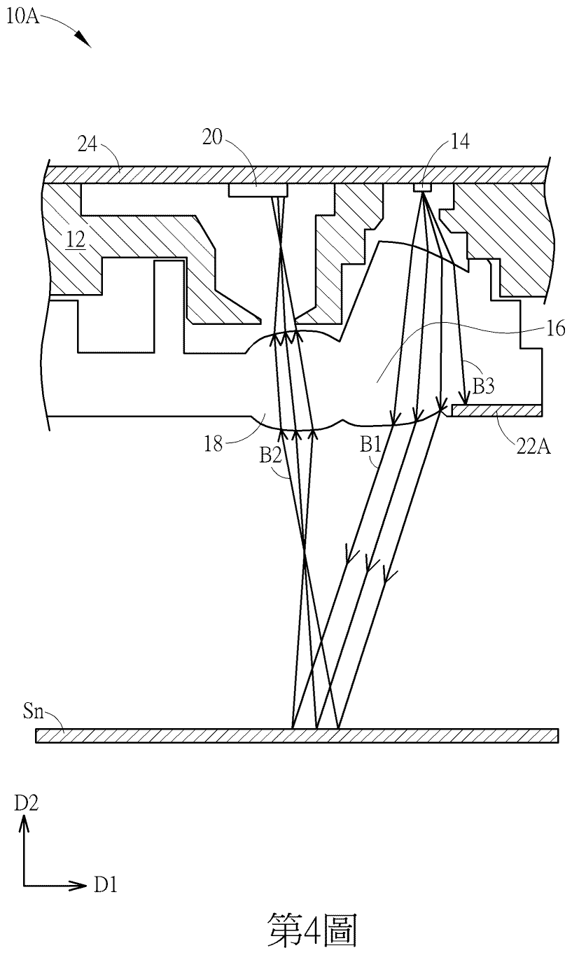

The first optical element 22 is not limited to the front prism block with the function of total internal reflection. Please refer to FIG. 4. FIG. 4 is a structural side view of the optical navigation device 10A according to other embodiment of the present invention. In this embodiment, elements having the same numerals as ones of the foresaid embodiment have the same structures and functions, and a detailed description is omitted herein for simplicity. The first optical element 22A of the optical navigation device 10A can be further designed as an opaque layer, such as a dark layer or a black layer, and used to isolate or absorb the stray light beam B3 for preventing the stray light beam B3 from reaching the navigation surface Sn. The first optical element 22A may be further designed as an optical deflection layer, the optical deflection layer can reflect the stray light beam B3 to prevent the stray light beam B3 from passing through the first optical element 22A and reaching the navigation surface Sn, or can refract the stray light beam B3 at a large angle for being transmitted in a direction away from the optical detector 20 through the navigation surface Sn. The first optical element 22A may be further designed as an optical diffusion layer, such as a matte structure, and used to diffuse the stray light beam B3 in a direction away from the navigation surface Sn.

In the present invention, the first optical element 22 can be preferably disposed adjacent to the output surface So of the illumination lens 16, and extended to the outer edge 26 of the illumination lens 16; besides, the first optical element 22 may be disposed around the output surface So, so that a specific side (such as a right side) of the first optical element 22 can be still extended to the outer edge 26 of the illumination lens 16, and the other side (such as a left side) of the first optical element 22 can be located between the illumination lens 16 and the imaging lens 18, or located on an outer edge of the imaging lens 18 opposite to the illumination lens 16. As the embodiment shown in FIG. 1, the first optical element 22 can be disposed around the lens component, and apply mechanical protection for the illumination lens 16, so as to prevent the illumination lens 16 and/or the imaging lens 18 from damage due to collision, abrasion, fingerprint or any potential scratching or contamination when those come to direct contact with the lens.

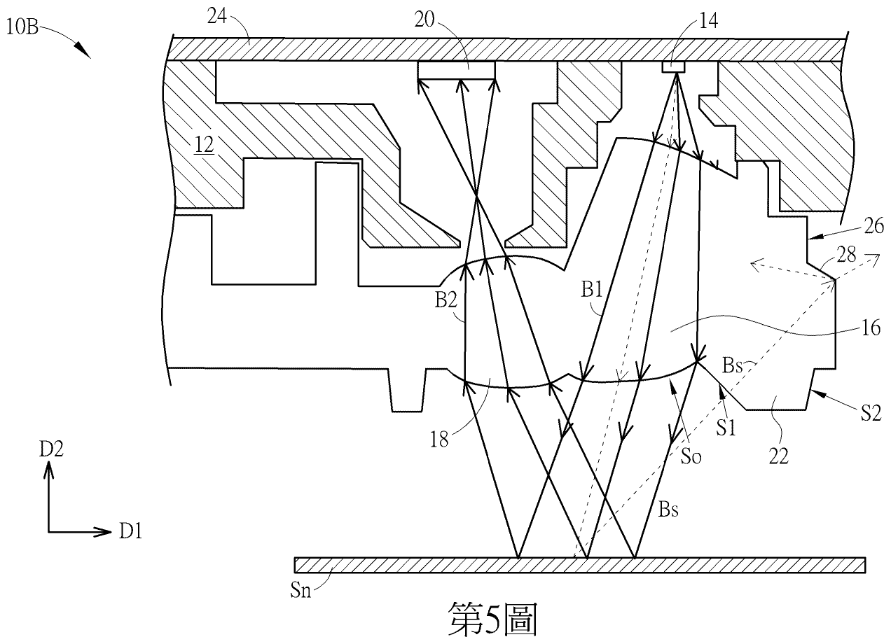

Please refer to FIG. 1 and FIG. 5. FIG. 5 is a structural side view of the optical navigation device 10B according to another embodiment of the present invention. In the embodiment, elements having the same numeral as ones of the foresaid embodiment have the same structures and functions, and the detailed description is omitted herein for simplicity. The optical navigation device 10B can further include a second optical element 28 disposed on a lateral surface of the illumination lens 16. The illumination beam B1 emitted by the illumination light source 14 can be projected onto the navigation surface Sn. Most of the illumination beam B1 can be reflected by the navigation surface Sn to form the reflection beam B2, and the reflection beam B2 can be transmitted towards the imaging lens 18 and received by the optical detector 20; a small amount of the illumination beam B1 may be transformed into a scattered beam Bs due to local unevenness of the navigation surface Sn. The scattered beam Bs may be transmitted towards the outer edge 26 of the illumination lens 16 through the navigation surface Sn. If the second optical element 28 is not disposed adjacent to the illumination lens 16, the scattered beam Bs may be returned to the navigation surface Sn and generate an undesired secondary signal Su via retro-reflection of the first optical element 22, as shown in FIG. 1.

Therefore, the second optical element 28 of the embodiment can be disposed on a possible transmission path of the scattered beam Bs, and used to refract and/or reflect the scattered beam Bs generated by the illumination beam B1 projected onto the navigation surface Sn, so as to cut down the retro-reflection of the scattered beam Bs and effectively eliminate the undesired secondary signal Su. As shown in FIG. 5, the scattered beam Bs is transmitted to the right side and the left side instead of returning to the navigation surface Sn; for example, the scattered beam Bs can be refracted towards the outside of the lens component (such as the right arrow), and further can be reflected towards to an upper area inside the lens component (such as the left arrow). Any element capable of preventing the scattered beam Bs from returning to the navigation surface Sn and entering the imaging lens 18 and the optical detector 20 can belong to a design scope of the second optical element 28 in the present invention.

The second optical element 28 can be defined as a side prism block, and can be monolithically integrated with the illumination lens 16, the imaging lens 18 and the first optical element 22 for setting as the lens component. The second optical element 28 can be used to refract and/or reflect the scattered beam Bs, and avoid the scattered beam Bs from returning to the navigation surface Sn and being received by the optical detector 20 due to retro-reflection, which means the second optical element 28 can eliminate the undesired secondary signal Su generated by the illumination beam B1 propagated between the illumination lens 16 and the navigation surface Sn. The second optical element 28 may have various forms. For example, the second optical element 28 can be an opaque layer used to isolate or absorb the scattered beam Bs generated by the illumination beam B1 projected onto the navigation surface Sn; or, the second optical element 28 can be an optical deflection layer used to reflect or refract the scattered beam Bs generated by the illumination beam B1 projected onto the navigation surface Sn; or, the second optical element 28 can be an optical diffusion layer used to diffuse the scattered beam Bs generated by the illumination beam B1 projected onto the navigation surface Sn, so that the scattered beam Bs is not returned to the navigation surface Sn.

In conclusion, the optical navigation device of the present invention can dispose the first optical element and the second optical element around the output surface of the illumination lens. The first optical element can change the transmission direction of the stray light beam inside the lens component, and eliminate the stray light beam generated by the illumination beam propagated between the illumination lens and the navigation surface, so as to prevent the stray light beam from being projected onto the navigation surface and received by the optical detector. The first optical element can use functions of light reflection, light absorption, light refraction and light diffusion to avoid the stray light beam from being projected onto the navigation surface, and can apply the mechanical protection for the illumination lens.

The second optical element can change the transmission direction of the scattered beam inside the lens component, and eliminate the undesired secondary signal generated by the illumination beam propagated between the illumination lens and the navigation surface, so as to avoid the scattered beam from being projected onto the navigation surface and received by the optical detector due to retro-reflection. The second optical element can use functions of the light reflection, the light absorption, the light refraction and the light diffusion to avoid the scattered beam from returning to the navigation surface. Comparing to the prior art, the optical navigation device of the present invention can dispose the first optical element and the second optical element adjacent to the illumination lens, which can effectively prevent the optical detector from detecting the stray light beam and the scattered beam, thereby significantly improving the detection accuracy of the optical detector.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. An optical navigation device, comprising:
a case movably located above a navigation surface;
an illumination light source disposed inside the case and adapted to emit an illumination beam;
an illumination lens disposed under the illumination light source and having an output surface, the illumination beam passing through the output surface to project onto the navigation surface;
an optical detector disposed inside the case and adapted to detect a reflection beam from the navigation surface;
a first optical element disposed adjacent to the output surface of the illumination lens and extended to an outer edge of the illumination lens, and adapted to eliminate a stray light beam generated by the illumination beam propagated between the illumination lens and the navigation surface and further to prevent the stray light from reaching the navigation surface.

2. The optical navigation device of claim 1, wherein the first optical element is a front prism block adapted to deflect the stray light beam away from a field of view of the optical detector.

3. The optical navigation device of claim 2, wherein the front prism block comprises a first surface and a second surface disposed on different positions, the first surface is disposed adjacent to the output surface, and the second surface is disposed adjacent to the outer edge.

4. The optical navigation device of claim 3, wherein the first surface has a function of total internal reflection, an included angle formed between a planar normal vector of the first surface and a planar normal vector of the navigation surface is substantially equal to forty-five degrees, and the first surface is adapted to totally reflect the stray light beam sideway to the second surface.

5. The optical navigation device of claim 3, wherein the second surface is adapted to refract the stray light beam in a preset direction away from the navigation surface.

6. The optical navigation device of claim 3, wherein the first surface is adapted to refract the stray light beam in another preset direction away from a field of view of the optical detector.

7. The optical navigation device of claim 1, wherein the first optical element is an opaque layer adapted to absorb the stray light beam to prevent the stray light beam from being projected onto the navigation surface.

8. The optical navigation device of claim 1, wherein the first optical element is an optical deflection layer adapted to reflect or refract the stray light beam away from the navigation surface.

9. The optical navigation device of claim 1, wherein the first optical element is an optical diffusion layer adapted to diffuse the stray light beam away from the navigation surface.

10. The optical navigation device of claim 1, wherein the first optical element is disposed around the output surface to provide mechanical protection.

11. The optical navigation device of claim 1, wherein the optical navigation device further comprises a second optical element disposed on a lateral surface of the illumination lens, and adapted to eliminate an undesired secondary signal generated by the illumination beam propagated between the illumination lens and the navigation surface.

12. The optical navigation device of claim 11, wherein the second optical element is a side prism block adapted to reflect and/or refract a scattered beam generated by the illumination beam projected onto the navigation surface, so as to cut down retro-reflection of the scattered beam and eliminate the undesired secondary signal.

13. The optical navigation device of claim 11, wherein the second optical element is an opaque layer adapted to absorb a scattered beam generated by the illumination beam projected onto the navigation surface.

14. The optical navigation device of claim 11, wherein the second optical element is an optical deflection layer adapted to reflect or refract a scattered beam generated by the illumination beam projected onto the navigation surface.

15. The optical navigation device of claim 11, wherein the second optical element is an optical diffusion layer adapted to diffuse a scattered beam generated by the illumination beam projected onto the navigation surface.

16. The optical navigation device of claim 1, wherein the optical navigation device further comprises an imaging lens disposed on a position of the illumination lens opposite to the first optical element to align with the optical detector.

17. The optical navigation device of claim 16, wherein the optical navigation device further comprises a lens component formed by the illumination lens, the imaging lens and the first optical element monolithically integrated with each other.
